(19) United States
(12) Patent Application Publication
(10) Pub. No.: US 2002/0080969 A1
(43) Pub. Date: Jun. 27, 2002

(54) Digital rights management system and method

(76) Inventor: John J. Giobbi, Northbrook, IL (US)

Correspondence Address: John J. Giobbi, 1980 Philips, Northbrook, IL, 60062, US

(21) Appl. No.: 09/750,487

(22) Filed: Dec. 27, 2000

(51) Int. Cl. H04L 9/00

(52) U.S. Cl. 380/277

(57) ABSTRACT

A method of managing digital rights comprises the following steps. First, a physical electronic key containing a key code is provided to a requesting user. Second, locked digital content is provided to the requesting user. The digital content is marked with an unlock code associated with the key code. Third, the locked digital content is received in a playing device that reads the key code and determines whether the key code is associated with the unlock code. Fourth, the playing device is enabled to unlock and play the digital content if the key code is associated with the unlock code. A digital right management system for implementing the foregoing method is also disclosed.

### FIELD OF THE INVENTION

The present invention relates generally to digital rights management and, more particularly, to a digital rights management system and method that effectively balances and protects the rights of both a consumer and a provider of digital content, such as music, video, and software.

### BACKGROUND OF THE INVENTION

The market for downloading digital content online is rapidly climbing because distribution of such content is inexpensive, fast, and easy and the quality of the content itself is acceptable. The market, however, remains disorganized due to competing standards, competing companies, discontented artists and producers, and outright theft of digital content.

Digital rights management (DRM) companies seek to solve the foregoing problems by delivering the digital content from the real producers to the right customers and ensuring that everyone who should be paid in fact is paid. DRM seeks to get everyone paid by managing the multiple steps for distributing digital content (music, video, software) online: watermarking, encryption, transaction management, and rights management. Some DRM companies perform all these steps, while other DRM companies specialize in one or two steps of the process.

First, watermarking stamps each piece of digital content with a digital mark so it can be tracked wherever it goes. Digital watermarks are just like paper watermarks, except they cannot be seen or heard. Special software is required to read a digital watermark.

Second, encryption scrambles watermarked digital content and stores it inside a digital safe for shipment around the Internet. The safe protects the content during shipping by allowing only those with the right software key to the safe to decrypt and use the content.

Third, transaction management handles actual payments for the digital content using credit card techniques found elsewhere in e-commerce. An order is placed, a credit card number is taken, account status is checked, and the exchange is authorized.

Finally, rights management manages the information about the digital content itself: what it is, who gets it, how it is delivered, how many times it may be used, how long the rights last, who gets paid, how much they get paid, and how. This information travels with the digital content in something called a digital permit. The permits rests on top of the digital content as it travels the Internet and allows legal users to enjoy the digital content for as long as the rights last.

The primary objective of DRM companies is to deploy technologies that protect digital content as it is distributed online. Some of these proposed technologies and DRM in general are discussed in the article “Digital Rights Management May Solve the Napster ‘Problem’,” Technology Investor, October 2000, pp. 24-27. Although such technologies should reduce the amount of digital theft, they generally favor the content provider at the expense of the consumer or favor the consumer at the expense of the content provider. That is, the rights of either the content provider or the consumer are compromised. For example, some technologies severely limit the consumer's ability to make extra copies of digital content even when the digital content is solely for personal use. Other technologies facilitate the making of copies of digital content which can be used by different consumers without the content provider being compensated by each consumer. The present inventor has discovered an improved DRM system and method that effectively balances and protects the rights of both the consumer and the content provider.

### SUMMARY OF THE INVENTION

In accordance with one aspect of the present invention, a method of acquiring and playing digital content comprises the following steps. First, a physical electronic key containing a key code is acquired from a key provider. Second, locked digital content is acquired from a content provider. The digital content is marked with an unlock code associated with the key code. Third, the locked digital content is entered into a playing device that reads the key code and determines whether the key code is associated with the unlock code. The device is enabled to unlock and play the digital content if the key code is associated with the unlock code.

In accordance with another aspect of the present invention, a method of managing digital rights comprises the following steps. First, a physical electronic key containing a key code is provided to a requesting user. Second, locked digital content is provided to the requesting user. The digital content is marked with an unlock code associated with the key code. Third, the locked digital content is received in a playing device that reads the key code and determines whether the key code is associated with the unlock code. Fourth, the playing device is enabled to unlock and play the digital content if the key code is associated with the unlock code.

In accordance with a further aspect of the present invention, a method of managing digital rights comprises the following steps. First, a physical electronic key containing a key code is provided to a requesting user. Second, an unlock code is applied to locked digital content acquired by the user. Third, a playing device receiving the digital content is enabled to unlock and play the digital content if the device reads the key code from the physical electronic key and determines that the key code is associated with the unlock code.

The foregoing DRM methods and systems for implementing the methods are advantageous in that they afford the key holder with tremendous versatility in copying and using locked digital content for personal use. At the same time, the rights of the content provider are protected because only the key holder with a key-enabled device can use the locked digital content. The key holder can copy the locked digital content as many times as desired, but can only play the locked digital content on a key-enabled device that is enabled with the physical electronic key coded to “unlock” the digital content. Thus, the digital content, even when copied, remains personal to the key holder. Individuals other than the key holder cannot use the locked digital content, even if they copy it, because such individuals do not hold the physical electronic key coded to unlock the digital content.

### BRIEF DESCRIPTION OF THE DRAWINGS

The foregoing and other advantages of the invention will become apparent upon reading the following detailed description and upon reference to the drawings in which:

FIG. 1 is a flow chart of a method of managing digital rights in accordance with the present invention; and

FIGS. 2, 3, and 4 are block diagrams of portions of a DRM system for implementing the method in FIG. 1.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

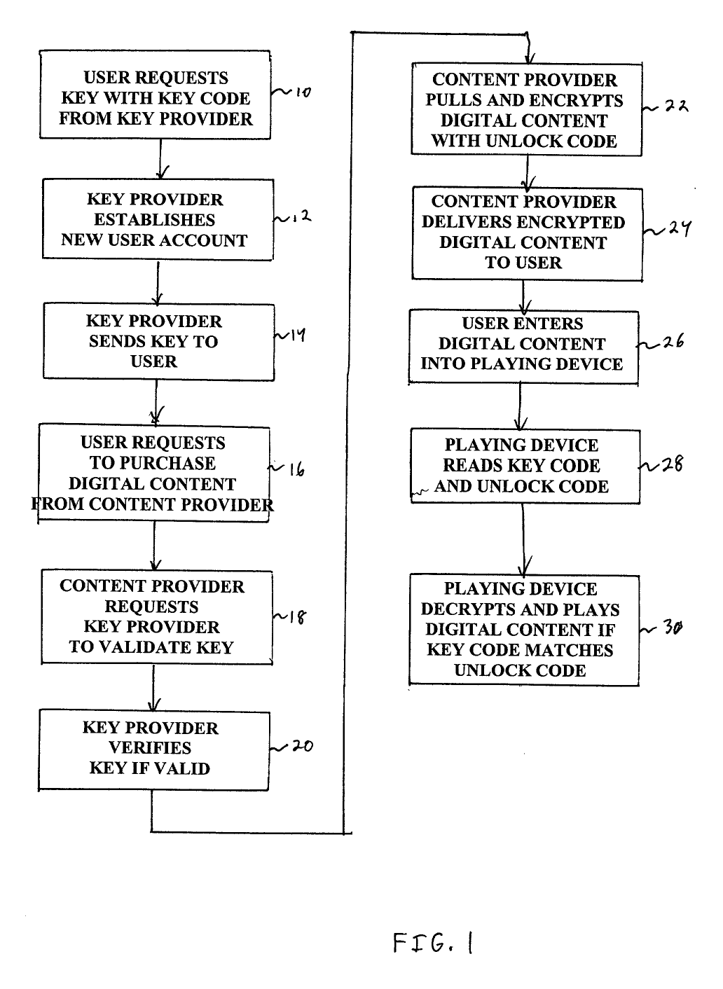

Turning now to the drawings and referring initially to FIG. 1, there is depicted a method of managing digital rights in accordance with the present invention. First, a new user requests a physical electronic key from a key provider (step 10). The key provider may offer a web site on the Internet and/or a toll free telephone number where the key may be acquired. In addition, the key provider may allow a key to be requested in writing, preferably using a form designed by the key provider. In one model the user may acquire as many keys as desired, while in another model each user is only entitled to a single key.

Second, in response to the user's request for a key, the key provider establishes a new secure account for that new user in a secure user account database (step 12). The new account includes user identification information, optional demographic information, and a unique key code to be stored on the key provided to the new user. The identification information includes the user's name, address, telephone number (home and/or business), e-mail address, and social security number. The demographic information may include the user's age, gender, marital status, income level, interests, hobbies, etc. The key code is preferably in the form of a string of alphanumeric characters of sufficient length to accommodate the number of keys that may be acquired from the key provider. To allow the user to view his or her account, including the key code, in the future, the user is preferably assigned a login name and password.

Third, the key provider ships the physical electronic key to the new user via a package courier such as the U.S. Postal Service, United Parcel Service, or Federal Express (step 14). In one pricing model the key is sent to the user at no charge, while in another pricing model the key must be purchased by the user. If the key must be purchased by the user, either the user must provide credit/debit card information to the key provider in step 10 to pay with a credit/debit card, or the key provider includes an invoice with the shipped key in step 14.

FIG. 2 is a block diagram of a system for implementing steps 10, 12, and 14 of the method of managing digital rights. The system includes the new user 100, the key provider's web site 102, and the user account database 104.

Referring back to FIG. 1, fourth, the user transmits his or her key code to a digital content provider, who has a cooperative relationship with the key provider, and requests to purchase digital content (music, video, or software) from that content provider (step 16). The content provider may offer a web site on the Internet containing a listing of digital content available for purchase. To transmit the key code to the content provider via the web site, the user may manually enter the key code onto a secure page of the web site. Alternatively, the transmission of the key code may be automatically implemented with wireless technology. Specifically, the user's computer may be outfitted with a detector that detects the key code in the user's key and then relays the key code to the content provider via the web site. The content provider may be affiliated with the key provider or may be separate from the key provider but have an arrangement therewith.

Fifth, the content provider requests the key provider to verify the key code transmitted by the user (step 18). The content provider may send this request to the key provider's web site. Sixth, the key provider in turn accesses the user's account in the user account database and determines whether the key code is in fact valid (step 20). The key provider may also determine whether the key code is associated with the user that transmitted the key code to the content provider. If the key code is rejected as being invalid, the content provider is so informed and the content provider in turn will not honor any request by the user to purchase digital content. If, however, the key code is accepted as being valid, the content provider is so informed and the purchase transaction proceeds.

Seventh, after securing validation of the key code, the content provider pulls the requested digital content from a digital content database/library, marks the digital content with an unlock code associated with the key code, and encrypts the marked digital content (step 22). The unlock code may simply be the key code itself, but encrypted for security.

Eighth, the content provider delivers the encrypted digital content to the user (step 24). The encrypted digital content may be delivered by downloading the encrypted digital content to the user's computer while the user is online at the content provider's web site, by attaching the digital content to an e-mail addressed to the user, or by shipping a disk containing the encrypted digital content to the user via a package courier. The user may pay for the digital content either by providing credit/debit card information to the content provider in step 16 or by paying off of an invoice included with delivered digital content. If the digital content is delivered online, the user is preferably required to provide the credit/debit card information and have such information approved as a prerequisite to delivery of the digital content. If the user possesses more than one physical electronic key and would like the acquired digital content to function with each of the user's keys, all of the unlock codes are applied to the digital content. The content provider charges the user based on the number of keys with which the user would like the digital content to function. For example, the user may be charged the same amount for each unlock code, or may be charged a larger amount for one unlock code and lesser amounts (e.g., surcharges) for additional unlock codes.

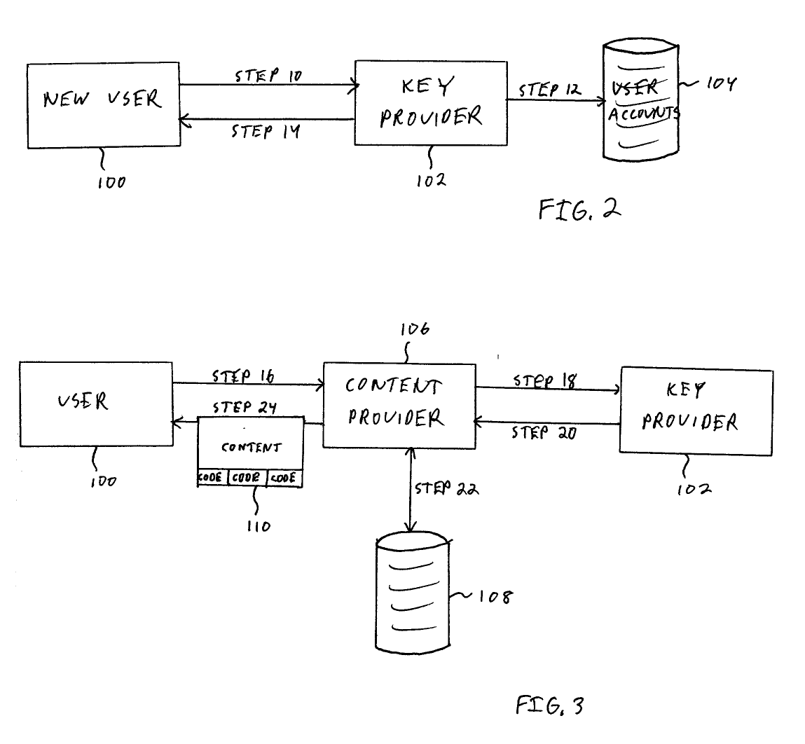

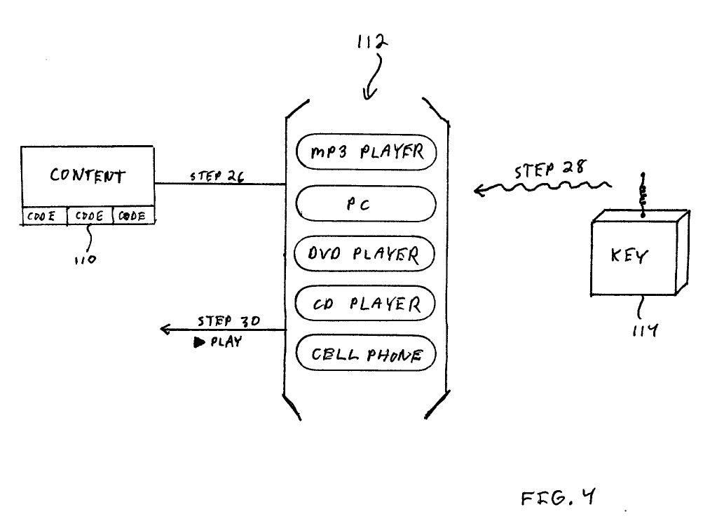

FIG. 3 is a block diagram of a system for implementing steps 16, 18, 20, 22, and 24 of the method of managing digital rights. The system includes the new user 100, the content provider 106, the key provider's web site 102, the digital content database 108, and the acquired digital content 110.

Returning to FIG. 1, ninth, the user enters the encrypted digital content into a playing device of a type suitable for playing the digital content (step 26). The device may, for example, be an MP3 player, a personal computer, a DVD player, a CD player, a cellular phone, or other portable device. In one embodiment, the device contains a wireless transceiver adapted to receive a radio frequency signal transmitted by a corresponding wireless transceiver in the user's physical electronic key. The wireless transceiver in the device is optionally tracked and “secured” for audit purposes by permanently including the device manufacturer's identification into the transceiver.

Tenth, with the user's physical electronic key within a short range (e.g., few meters) of the playing device, the playing device reads (1) the key code carried in a radio frequency signal transmitted by the transceiver in the key to the transceiver in the device and (2) the unlock code marked on the encrypted digital content (step 28). The device contains decryption software for decrypting the encrypted digital content to the extent necessary to read the unlock code. The device manufacturer has a cooperative relationship with the content provider so that the decryption software is suitable for decrypting the encrypted digital content. For example, the device manufacturer may be affiliated with the content provider or may be separate from the content provider but have an arrangement therewith.

Eleventh, the playing device compares the key code and the unlock code and determines whether the key code is associated with the unlock code (step 30). Steps 29 and 30 may be performed, for example, when the user presses a “play” button on the playing device or when the user first enters the encrypted digital content into the playing device. If the key code is associated with the unlock code, the device decrypts and plays the digital content. If the key code is not associated with the unlock code, the device does not play the digital content. If the unlock code is simply the key code itself, then the foregoing comparison determines whether there is a match between the key code and the unlock code. In a preferred embodiment, the device continues to play the digital content only while the key is sufficiently close to the device to communicate the key code to the device and allow the device to compare the key code to the unlock code encrypted with the digital content even while the digital content is being played. If the key is moved out of range, the device is no longer enabled to decrypt and play the digital content. In an alternative embodiment, once the device is initially enabled to decrypt and play the digital content, the device remains enabled until either the “play” function is stopped or the digital content is removed from the device, even if the key is moved out of range such that the key can no longer communicate the key code to the device.

FIG. 4 is a block diagram of a system for implementing steps 26, 28, and 30 of the method of managing digital rights. The system includes the encrypted digital content 110, the key-enabled playing devices 112, and the user's physical electronic key 114.

As stated above, the user's physical electronic key and the key-enabled playing device contain respective wireless transceivers to communicate the key code in the key to the device. In a preferred embodiment, the transceivers are small, inexpensive Bluetooth radio chips that operate in the unlicensed ISM band at 2.4 GHz and avoid interference from other signals by hopping to a new frequency after transmitting or receiving a packet. The radio chips are plugged into electronic devices, which can then communicate over short distances and through obstacles by means of radio waves. Bluetooth is a term used to describe the protocol of a short range (e.g., about 10 meters) frequency-hopping radio link between devices containing the radio chips. These devices are then termed “Bluetooth-enabled.” The radio link replaces a cable that would otherwise be used to connect the devices. Further details concerning Bluetooth wireless technology may be obtained from www.bluetooth.com. Wireless technologies other than Bluetooth may be used to communicate the key code from the user's physical electronic key to the playing device.

In other alternative embodiments, the communication between the user's physical electronic key and the playing device is not wireless. Rather, in one alternative embodiment, the user's physical electronic key communicates the key code to the playing device via a transmission line such as a serial cable that plugs into the key at one end and the playing device at the other end. In another alternative embodiment, the key is a smart card or magnetic card into which the key code is encoded, and the key is configured to physically fit into a card reader slot on the playing device.

The above-described DRM method and system for implementing the method are advantageous in that they afford the key holder with tremendous versatility in copying and using encrypted digital content for personal use. At the same time, the rights of the content provider are protected because only the key holder with a key-enabled device can use the encrypted digital content. The key holder can copy the encrypted digital content as many times as desired, but can only play the encrypted digital content on a key-enabled device that is enabled with the physical electronic key coded to decrypt the encrypted digital content. Thus, the digital content, even when copied, remains personal to the key holder. Individuals other than the key holder cannot use the encrypted digital content, even if they copy it, because both the original and copies of the encrypted digital content are still encrypted and the individuals do not hold the physical electronic key coded to decrypt the digital content.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A method of acquiring and playing digital content comprising:
acquiring a physical electronic key containing a key code from a key provider;
acquiring locked digital content from a content provider, the digital content being marked with an unlock code associated with the key code; and
entering the locked digital content into a playing device that reads the key code and determines whether the key code is associated with the unlock code, the device being enabled to unlock and play the digital content if the key code is associated with the unlock code.

2. The method of claim 1, wherein the step of acquiring the physical electronic key includes providing the key provider with user identification information for use by the key provider in establishing a user account, the user account including the user identification information and the key code.

3. The method of claim 1, wherein the step of acquiring the locked digital content includes providing the content provider with the key code for use by the content provider in validating the key code prior to providing the locked digital content.

4. The method of claim 1, wherein the locked digital content is locked by encryption and unlocked by decryption.

5. The method of claim 1, wherein the step of acquiring the physical electronic key includes accessing a first web site of the key provider and requesting the physical electronic key via the first web site, and wherein the step of acquiring the locked digital content includes accessing a second web site of the content provider and requesting the digital content via the second web site.

6. The method of claim 1, wherein the physical electronic key is acquired at no charge, and wherein the digital content is purchased.

7. A method of managing digital rights comprising:
providing a physical electronic key containing a key code to a requesting user;
providing locked digital content to the requesting user, the digital content being marked with an unlock code associated with the key code;
receiving the locked digital content in a playing device that reads the key code and determines whether the key code is associated with the unlock code; and
enabling the playing device to unlock and play the digital content if the key code is associated with the unlock code.

8. The method of claim 7, further including establishing a user account including user identification information and the key code for the requesting user prior to the step of providing the physical electronic key.

9. The method of claim 7, further including obtaining and validating the key code for the requesting user prior to the step of providing the locked digital content.

10. The method of claim 7, further including administering a first web site for receiving a request for the physical electronic key from the requesting user, and administering a second web site for receiving a request for the locked digital content from the requesting user.

11. The method of claim 7, wherein the locked digital content is locked by encryption and unlocked by decryption.

12. The method of claim 7, wherein the physical electronic key and the playing device include respective wireless transceivers for communicating the key code from the key to the playing device.

13. A method of managing digital rights, comprising:
providing a physical electronic key containing a key code to a requesting user;
applying an unlock code to locked digital content acquired by the user; and
enabling a playing device receiving the digital content to unlock and play the digital content if the device reads the key code from the physical electronic key and determines that the key code is associated with the unlock code.

14. The method of claim 13, further including establishing a user account including user identification information and the key code for the requesting user prior to the step of providing the physical electronic key.

15. The method of claim 13, further including obtaining and validating the key code for the requesting user prior to the step of applying the unlock code to the locked digital content.

16. The method of claim 3, wherein the physical electronic key and the playing device include respective wireless transceivers for communicating the key code from the key to the playing device.

17. A digital rights management system, comprising:
a physical electronic key containing a key code and provided to a requesting user;
means for providing locked digital content to the requesting user, the digital content being marked with an unlock code associated with the key code; and
a playing device for receiving the locked digital content, receiving the key code, and determining whether the key code is associated with the unlock code, the playing device being enabled to unlock and play the digital content if the key code is associated with the unlock code.

18. The system of claim 17, wherein the physical electronic key and the playing device include means for communicating the key code to the playing device.

19. The system of claim 17, wherein the means for providing the locked digital content to the requesting user includes a web site on the Internet.

20. The system of claim 19, wherein the means for providing the locked digital content secures validation of the key code prior to providing the locked digital content.

21. The system of claim 17, further including means for providing the physical electronic key, and establishing a user account including user identification information and the key code for the requesting user prior to providing the key.

22. The system of claim 21, wherein the means for providing the physical electronic key includes a web site on the Internet.

23. A digital rights management system, comprising:
a physical electronic key containing a key code;
locked digital content marked with an unlock code associated with the key code; and
a playing device for receiving the locked digital content, receiving the key code, and determining whether the key code is associated with the unlock code, the playing device being enabled to unlock and play the digital content if the key code is associated with the unlock code.

24. The system of claim 23, wherein the digital content is locked by encryption and unlocked by decryption.

25. The system of claim 23, wherein the physical electronic key and the playing device include means for communicating the key code to the playing device.
